(19) United States
(12) Patent Application Publication
(10) Pub. No.: US 2023/0074968 A1
(43) Pub. Date: Mar. 9, 2023

(54) MACHINE LEARNING CLASSIFICATION OF SIGNALS AND RELATED SYSTEMS, METHODS, AND COMPUTER-READABLE MEDIA

(71) Applicant: Northrop Grumman Systems Corporation, Falls Church, VA (US)

(72) Inventors: Benjamin C. Gookin, Denver, CO (US); Nathanael M. Harmon, Colorado Springs, CO (US); Justin Kopacz, Aurora, CO (US); Michael Herndon, Lakewood, CA (US)

(21) Appl. No.: 17/404,160

(22) Filed: Aug. 17, 2021

(51) Int. Cl. G06N 3/08; G06K 9/62

(52) U.S. Cl. CPC G06N 3/08; G06K 9/6256; G06K 9/6267

(57) ABSTRACT

Classification of signals using machine learning and related systems, methods and computer-readable media are disclosed. A signal classification system includes a sentence embedding model network, a convolutional generator network, and a classifier network. The sentence embedding model network is trained to convert a body of sentences correlated to different signal modulation schemes into a latent space. The convolutional generator network is configured to project samples of a measured signal into the latent space. The classifier network is configured to classify the measured signal from the latent space responsive to a projection of the samples of the measured signal into the latent space. A method includes training a sentence embedding model network to convert descriptive sentences to a latent space, the descriptive sentences correlated to different signal modulation schemes. The method also includes training a convolutional generator network to project samples of a measured signal into the latent space.

### TECHNICAL FIELD

This disclosure relates generally to classification of radio frequency (RF) signals using machine learning, and more specifically to classification of RF signals using generative adversarial networks.

### BACKGROUND

Signal classification techniques may be useful in various environments to detect information regarding wireless signals in these environments. Signal classification may, however, be a difficult task, especially where multiple different wireless signals are present and multiple different types of modulation have been used for modulating the wireless signals.

A rapidly evolving RF threat environment poses significant challenges to current architectures and data processing pipelines. Signal classification systems are faced with software defined radios with dynamic signal characteristics, chaotic waveforms, and high mobility. Also, there is an ever increasing number of devices (e.g., internet of things (IoT) devices), many of which run on low power.

### BRIEF SUMMARY

In some embodiments a signal classification system includes a sentence embedding model network trained to convert a body of sentences correlated to different signal modulation schemes into a latent space, a convolutional generator network configured to project samples of a measured signal into the latent space, and a classifier network configured to classify the measured signal from the latent space responsive to a projection of the samples of the measured signal into the latent space.

In some embodiments a method of operating a signal classification system includes training a sentence embedding model network to convert descriptive sentences to a latent space. The descriptive sentences are correlated to different signal modulation schemes. The method also includes training a convolutional generator network to project samples of a measured signal into the latent space.

In some embodiments a computer-readable medium has computer-readable instructions stored thereon. The computer-readable instructions are configured to instruct one or more processors to train a sentence embedding model network to convert a body of sentences correlated to different signal modulation schemes into a latent space. The computer-readable instructions are also configured to instruct the one or more processors to train a convolutional generator network to project measured signals into the latent space. The computer-readable instructions are further configured to instruct the one or more processors to project samples of a measured signal to the latent space and classify, with a classifier network, the signal according to one or more of the different signal modulation schemes based, at least in part, on a projection of the samples to the latent space.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of a signal classification system, according to some embodiments;

FIG. 2 is a histogram of an example output of a classifier network of the signal classification system of FIG. 1 for a GFSK-modulated signal input;

FIG. 3 is a plot illustrating an example of a latent space;

FIG. 4 is a plot illustrating an example of a latent space that is not trained for GFSK modulation;

FIG. 5 is a histogram of an example output of the classifier network of the signal classification system of FIG. 1 without GFSK training;

FIG. 6 is a plot illustrating an example of a latent space that is not trained for BPSK modulation;

FIG. 7 is a flowchart illustrating a method of operating a signal classification system, according to some embodiments; and

FIG. 8 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Wide-band RF sensing may result in detection of emissions from multiple different RF devices. Signal classification systems used to process these emissions may use band-pass filter banks to separate different RF signals originating from the multiple different RF devices, and perform signal identification and geolocation individually on the separated RF signals.

While this type of processing architecture may be parallelizable, the separation of the individual RF signals removes the context of each signal within the overall RF environment. With sufficient signal to noise ratio (SNR), the different RF devices may be parameterized and their corresponding RF signals may be compressed into metadata. Following this automatic processing, human analysts may then internalize the parameterized data and fuse the parameterized data with their own domain knowledge to understand the context and overall RF environment.

During parameterization a center frequency and bandwidth of each different RF signal may be measured and each different RF signal's modulation scheme may be estimated. Modulation recognition may involve processing a digitally sampled waveform, or in-phase/quadrature phase (IQ) data, to estimate the analog or digital modulation. Modulation recognition may be a classification problem, and may be performed using a variety of different processes. For example, modulation recognition may include using human-engineered features such as cumulants, which may involve using decision-theoretics, pattern recognition, or support vector machines (SVMs) (e.g., performed with a sequence of 2048 or 4096 samples, without limitation).

In decision-theoretic approaches, a decision tree may be used to reason over the statistically derived signal features to narrow down the classification space through multiple binary decisions. The decision tree may determine if modulation of the waveform is digital or analog. If analog, the decision tree may decide if the waveform corresponds to a vestigial sideband (VSB) or amplitude modulation (AM)/multiple amplitude shift keying (MASK). The process proceeds until a modulation is selected. The SVM and even some neural network-based techniques may use the same statistically derived features and learn the decision boundaries to classify the waveform. Since the feature extraction process has already been performed by a human, these models may generally converge faster than deep learning-based approaches. These models, however, may be limited by the quality of the extracted features. Additionally, as the threat environment evolves, these hand-crafted features may not be robust enough to capture subtle details that separate the waveforms.

Rather than depending on human-engineered or statistically defined features, deep learning may be used to learn representative features useful for classification. Convolutional Neural Networks (CNN) may effectively capture patterns that manifest over varied length inputs and may be used on simulated signals with Additive White Gaussian Noise (AWGN) to identify modulation. These networks encode the signal into a latent representation, and are analogous to a hierarchical bank of nonlinear matched filters that are robust to channel impairments.

These CNN-based approaches may outperform conventional systems using higher-order cumulants when trained on only the raw IQ data (e.g., no expert features extracted), especially for signals with a low SNR. Domain transfer learning with CNNs for training on synthetic signals and testing on signals transmitted over-the-air, has shown CNNs are able to extract representative features that account for noise introduced by transmitting and/or receiving systems and over-the-air effects including fading, Doppler shift, and multipath in addition to AWGN.

Generative Adversarial Networks (GANs) are a relatively recent advancement in the machine learning domain and may be applied in multiple applications including synthetic data generation, image style transfer, and image super-resolution. A GAN may include two neural networks, a generator that attempts to synthesize data that looks as realistic as possible, and a discriminator that attempts to distinguish real data (e.g. low-volume training data) from the fake data created by the generator. The only input to the generator is a random vector. The generator may not be provided examples of real data. Rather, the generator may learn to imitate the distribution of the target dataset through the gradient propagated from the discriminator. Further, a binary indicator provided by the discriminator may indicate if a sample originated from the true dataset or the generator.

Conditional GANs may use a generator where the random input is extended with some non-random known parameter (e.g., a class label). For example, a GAN may be conditioned to generate examples of Modified National Institute of Standards and Technology (MNIST) data based on a class label. This technique may be used to create large synthetic datasets by leveraging a GAN to generate data for each class label, after training the GAN on a small volume of clean labeled data.

In the RF domain, GANs may be used to approximate over-the-air channel for a cognitive radio system. Since the GAN is a differentiable model, this technique may enable the end-to-end training of a novel waveform in the form of a nonlinear encoder (modulator) and decoder (demodulator) specially tuned and optimized for a given channel. A GAN may be used to learn a mapping from IQ or RF data, and imitate a document embedding model.

Image captioning goes beyond listing the contents of an image and seeks to understand how the objects interact with each other. Image captioning is a difficult machine-learning task where a human-readable text description is generated given an input image. Image captioning may involve combining two fields of machine learning: computer vision and natural language processing. Marrying these two fields may be done by using a pretrained CNN image classifier to detect the objects in an image, and to use these outputs as features for a recurrent neural network (RNN) to generate descriptive words. A CNN and a RNN may be trained together to perform this task on a dataset of images and associated captions.

Two techniques may be used for performing image captioning: top-down and bottom-up image captioning. Image captioning may retrieve human-written captions or those that generate new captions. Further, attention mechanisms may selectively highlight areas in an image to provide explainability to the model's output.

Research in deep learning-based image captioning has shown that artificial intelligence (AI) systems may automatically generate a natural language description of input images. While many applications of machine learning to image processing revolve around locating and classifying objects within an image, image captioning goes beyond listing the contents of an image and seeks to understand the full context of the image and how the objects interact with each other. Further, users may create queries and ask questions to extract information from the input image.

Machine learning provides an opportunity to minimize human intervention and accelerate the adaptation to new stimulus. Techniques according to some embodiments disclosed herein may solve historically difficult problems such as signal identification and geolocation under co-channel interference. Signal classification systems according to some embodiments may include artificial intelligence (AI) systems that perform geolocation, co-channel interference mitigation, signal identification, and estimation of identification for novel signals. As used herein, the term “novel signal” refers to a particular modulation scheme for a signal that an AI system is not specifically trained to recognize.

Expanding on a capability to convert from IQ data into words may enable provision of a general RF caption with a general description of the contents of a collection of RF signals. In the RF domain, a caption would be useful in describing the contents of a collection of RF signals in a spectral environment. Rather than simply parameterizing the contents of the spectrum, embodiments disclosed herein may include generation of a caption that includes additional context for the spectral environment. In contrast to mere caption retrieval, some embodiments disclosed herein may include generative approaches that analyze IQ data, detect modulation features, and create a new set of descriptive words from a separate word corpus.

When applied to the RF processing domain, a semantic representation of the RF environment may aid an analyst in understanding the context of the domain. Instead of analyzing independent parameterized samples for each of the detected emissions (e.g., center frequency, bandwidth, modulation, etc.), an overall description of the environment may be more meaningful to an analyst. This type of information may be useful to describe a congested environment, or may be useful in understanding the behaviors and characteristics of new devices.

In some embodiments, disclosed herein are systems, methods, and devices related to a generative adversarial network architecture that projects RF data into a latent space learned by a document embedding model (e.g., a paragraph vector algorithm such as “Doc2Vec”). Rather than simply performing modulation recognition on an input signal, the projection enables description of an input signal using words. Automatic text-based description may represent a significant advancement over conventional signal parameterization and modulation recognition, as text-based description may provide a richer description of a signal than conventional signal parametrization, and text-based description may indicate characteristics of new signal types that were not exposed to the system during training.

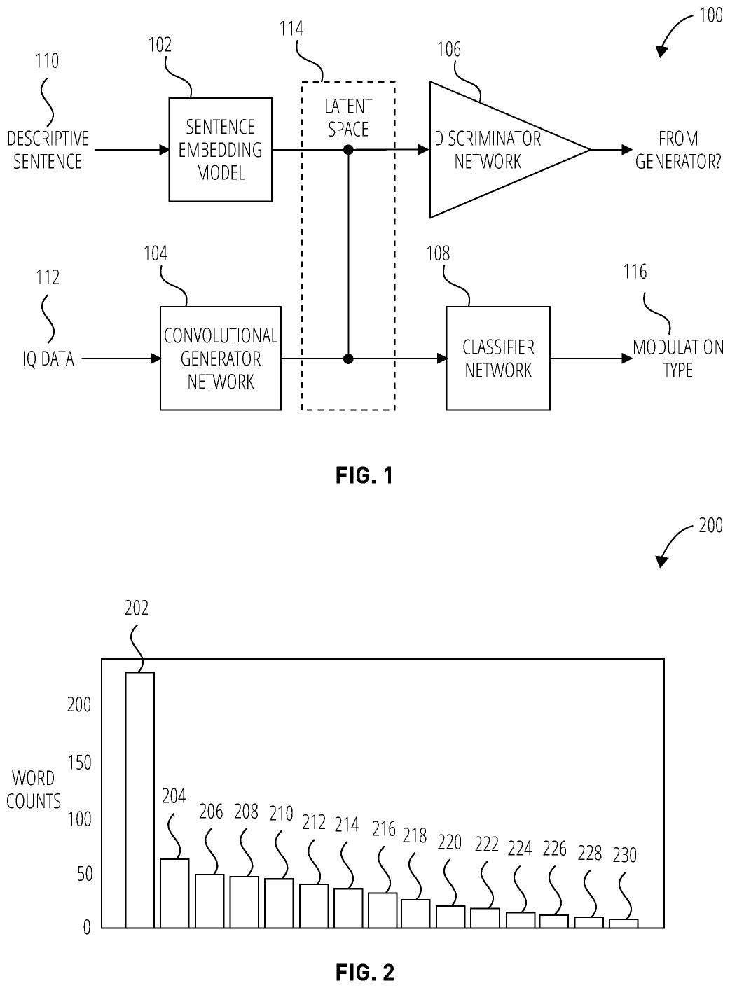

FIG. 1 is a block diagram of a signal classification system 100, according to some embodiments. Rather than performing modulation recognition with the end goal of yielding a single modulation type, some embodiments disclosed herein may provide descriptions of an input signal with a text output. The signal classification system 100 of FIG. 1 is configured to accomplish this task. The signal classification system 100 is a GAN-based architecture that maps IQ data 112 into a latent space 114 that understands the semantic differences between modulations and provides a mechanism to create a text-based description of the input signal. The IQ data 112 may be samples of a measured signal that is desired to be classified using the signal classification system 100.

The signal classification system 100 involves training a convolutional generator network 104, which learns to imitate a document embedding model, using a multi-operation process. The signal classification system 100 includes four separate neural networks. A first neural network may include a sentence embedding model 102 (e.g., a document embedding model) that is trained to convert descriptive sentences 110 to a latent space 114 (e.g., a 100-dimensional latent document space or semantic embedding space). By way of non-limiting example, the sentence embedding model 102 may be trained based, at least in part, on information from a corpus of technical journals that focuses on signal processing and modulation recognition.

A second neural network may include a convolutional generator network 104 (e.g., a GAN architecture) that is conditioned on IQ data 112. The convolutional generator network 104 may be used to learn the projection of IQ data 112 into the same latent space 114.

A third neural network may include a discriminator network 106 that attempts to distinguish outputs originating at the convolutional generator network 104 (data generated by the convolutional generator network 104 to mimic real IQ data 112) from outputs originating at the sentence embedding model 102.

A fourth neural network may include a classifier network 108 that classifies the modulation type 116 directly from the latent space 114. The classifier network 108 may be a small classifier neural network that operates on the learned latent space 114, which is useful to bootstrap the training of the generator and create a gradient useful for fitting the distribution of the document embedding space. The classifier network 108 may classify the modulation type 116 directly from the embedded space.

In operation during a training operation (inference), the discriminator network 106 and the classifier network 108 may not be used, and samples of the IQ data 112 condition the convolutional generator network 104 to project the samples into the latent space 114. A predetermined number K of points nearest to a projected IQ sample may be selected. The selected points may be used to create a description of the IQ sample.

The sentence embedding model 102 may use a paragraph vector algorithm referred to herein as “Doc2Vec.” The Doc2Vec model is inspired by a word vector embedding referred to herein as “Word2Vec,” where the task is to predict a next word in a sentence given some context. The word vector embedding method maps every word to a unique column in a weight matrix in a shallow neural network, and this weight matrix is used as features for prediction of the next word in a sentence. The training of word vector embedding model is an unsupervised task that learns semantics directly from the corpus of text. The Doc2Vec algorithm extends this framework by including a unique vector for every paragraph, or sentence, depending on how the words are grouped, along with the unique vectors for every word. These matrices are combined and used as features to predict the next word in a context. The contexts are sampled by a fixed length sliding window over a given paragraph, where the paragraph vector is shared across all contexts generated from the same paragraph, but not across paragraphs, and the word vectors are shared across all paragraphs. After Doc2Vec is trained, the paragraph vectors may be used as features for the entire paragraph, or sentence, for downstream deep learning tasks. The paragraph vectors may also be used as high-dimensional semantic representations of the paragraph.

An architecture of the convolutional generator network 104 is shown in Table 1. By way of non-limiting example, the input to the generator may be a 1024×2 sample of IQ and a 1024×1 noise vector to provide a random state to the generator. Multiple convolutional layers may be used to reason over the time-series data and extract feature-level information. The dense layer performs a final transformation into the latent space 114 (e.g., the 100-dimensional embedding space).

TABLE 1
Signal Classification Network Architecture Used for Modulation
Recognition Under Co-channel Interference

| Type | Filters | Size/Dilation | Input | Output |
|---|---|---|---|---|
| 2DConv | 16 × 1 | 16 × 1/1 | 1024 × 1 × 3 | 512 × 16 × 3 |
| BatchNorm | | | 512 × 16 × 3 | 512 × 16 × 3 |
| Relu | | | 512 × 16 × 3 | 512 × 16 × 3 |
| 2DConv | 32 × 1 | 16 × 1/1 | 512 × 16 × 3 | 256 × 32 × 3 |
| BatchNorm | | | 256 × 32 × 3 | 256 × 32 × 3 |
| Relu | | | 256 × 32 × 3 | 256 × 32 × 3 |
| 2DConv | 64 × 1 | 16 × 1/1 | 256 × 32 × 3 | 128 × 64 × 3 |
| BatchNorm | | | 128 × 64 × 3 | 128 × 64 × 3 |
| Relu | | | 128 × 64 × 3 | 128 × 64 × 3 |
| Dense | | | 24576 | 100 |

An architecture of the discriminator network 106 is provided in Table 2. The input to the discriminator network 106 is the embedding learned by the Doc2Vec model or the output of the convolutional generator network 104. The discriminator network 106 uses three full-connected layers to perform binary classification, depicted by the final output of size 1.

TABLE 2
Discriminator Architecture Used for Identifying Generated
Data vs. Doc2Vec data

| Type | Input | Output |
|---|---|---|
| Dense | 107 | 1024 |
| BatchNorm | 1024 | 1024 |
| Relu | 1024 | 1024 |
| Dense | 1024 | 512 |
| BatchNorm | 512 | 512 |
| Relu | 512 | 512 |
| Dense | 512 | 1 |

An architecture of the classifier network 108 is provided in Table 3. Since the input to the classifier network 108 is the embedding learned by the sentence embedding model 102 (e.g., the Doc2Vec model), additional feature extraction may not be used. The classifier uses 3 fully-connected layers to yield a one-hot-encoded vector.

TABLE 3
Generator Network Architecture Used to Imitate the Doc2Vec Embedding

| Type | Input | Output |
|---|---|---|
| Dense | 107 | 256 |
| BatchNorm | 256 | 256 |
| Relu | 256 | 256 |
| Dense | 256 | 128 |
| BatchNorm | 128 | 128 |
| Relu | 128 | 128 |
| Dense | 128 | 7 |
| Relu | 7 | 7 |

Training the signal classification system 100 may use two separate datasets. A first dataset may include a corpus of technical journal papers. By way of non-limiting example, a corpus of 11120 papers scraped from arXiv, Google Scholar, and IEEE relating to digital communications and modulation recognition was used to train the signal classification system 100. A custom web scraper was developed to download PDF text fields for all papers in a query. To ensure sufficient class coverage, each modulation of interest was also individually queried (e.g., four-level pulse-amplitude modulation, or “PAM4”).

The documents are parsed into raw text (e.g., using a PDF file miner software script such as the Python package pdfminer.six, without limitation). The raw text is then separated into sentences (e.g., using a rules-based Natural Language Processing (NLP) pipeline such as in spaCy, which is an open-source NLP processing software library). Finally, the sentences are filtered to include only the mention of a single modulation type, such that the mapping is exclusive to a single modulation of interest.

A second dataset may be a large heteroscedastic dataset of raw IQ data. A custom GNU Radio-based RadioML simulator that supports creating ensembles of emitters and collectors, and computes signal delays and Doppler shifts based, at least in part, on the scenario geometry, may be used. Each emitter may be configured to have a variable bandwidth between 5 KHz and 1 MHz, a center frequency offset of ±5 Mhz, a SNR between −18 dB and 18 dB, and a modulation from the following set:
phase-shift keying (PSK) (e.g., 2-PSK, 4-PSK, 8-PSK, without limitation)
pulse-amplitude modulation (PAM) (e.g., PAM4, without limitation)
quadrature amplitude modulation (QAM) (e.g., QAM16, QAM64, without limitation)
Gaussian frequency-shift keying (GFSK)
continuous-phase frequency-shift keying (CPFSK)

To simplify the second dataset, the simulator may be configured to create an ensemble with only a single collector and a single emitter. The emitter may be configured to have a fixed center frequency offset of 0 Hz, a bandwidth between 50 KHz and 1 MHz, a SNR between 0 dB and 18 dB, and a random modulation from the set. The collector samples the 10 MHz bandwidth and collects a 1024-length observation. This process may be repeated to generate an archive of 350,000 examples between the 8 modulation types, translating to 43,000 examples per modulation. The dataset may then be partitioned into an 80-20 training/testing split.

The sentence embedding model 102 (e.g., the Doc2Vec model, without limitation) is trained on the unstructured document text corpus that have been parsed into sentences, as discussed above. The text are segmented into lists of word tokens w₁, w₂, . . . , w_{T} for a given document, and the prediction of the next word in a sentence is formally defined as maximizing the log probability,

$$\frac{1}{T} {\sum }_{t = k}^{T - k} log p ( {w}_{t} \vert {w}_{t - k} , … , {w}_{t + k} ) ,$$

where the probability of the next word is calculated with a multiclass classifier, such as a softmax function,

$$p ( {w}_{t} \vert {w}_{t - k} , … , {w}_{t + k} ) = \frac{{e}^{{y}_{{w}_{t}}}}{{\sum }_{i} {e}^{{y}_{i}}} .$$

Each of yᵢ is an un-normalized log probability for each output word i, as computed by

[symbol]

=b+Uh( [symbol] ₜ₋ₖ, . . . , [symbol] ₜ₊ₖ; W),

where U, b are the softmax parameters, and h is a construction of the word vectors, W, and the paragraph vectors D. The formalism outlined above involves the equation for the un-normalized log probability y above including a unique paragraph vector D.

A Doc2Vec model in the Gensim Python package may be used. Training of the neural network weight matrices in the above equation for the un-normalized log probability y above may be performed using stochastic gradient descent and backpropagation, where at every step the gradient error is calculated from a fixed-length context sample from a random document. Given a relatively small number of documents, training on a moderately fast central processing unit (CPU) may take substantially ten minutes for forty epochs, where each epoch corresponds to one pass through the corpus of tokenized documents.

To train the signal classification system 100, the convolutional generator network 104 synthesizes samples while the discriminator network 106 attempts to distinguish synthesized samples (originating at the convolutional generator network 104) from real measured samples. An auxiliary classification task is also trained, which is a method used to improve the quality of the convolutional generator network 104. Providing additional losses to the convolutional generator network 104 from this classifier network 108 typically creates richer gradients and reduces the chances of the generator converging on a local minimum.

Sentences that include a name of a modulation from the training corpus are encoded using Doc2Vec and form the set of real data. The convolutional generator network 104 is given unlabeled IQ signals from the RF dataset with an additional noise vector to allow stochasticity in the convolutional generator network 104, and outputs a nonlinear projection of the IQ signal in the Doc2Vec embedding space.

The discriminator network 106 receives a batch of the projections from the convolutional generator network 104 plus the modulation label of the IQ that was projected, along with real Doc2Vec vectors labeled with the modulation the sentences include. The discriminator network 106 learns to classify if the projection came from the real set of projections or from the convolutional generator network 104 conditionally based on the modulation. If the discriminator network 106 is successful in separating the projections of the convolutional generator network 104 from the real encodings, the loss is back-propagated though the generator to improve the projections of the convolutional generator network 104. The loss may be a standard minimax loss.

In addition to processes performed by the discriminator network 106 and the convolutional generator network 104, the classifier network 108 is trained with the convolutional generator network 104 for the first two epochs. The IQ projection of the convolutional generator network 104 is given as input into the classifier network 108, which attempts to classify the modulation of the original IQ that was projected by the convolutional generator network 104 into a modulation type 116. The loss from the classifier network 108 is back-propagated through the convolutional generator network 104 to further improve the IQ projections of the convolutional generator network 104. The classification may be calculated using mean squared error over a one-hot-encoded label.

In an inference-only mode of the signal classification system 100, IQ data 112 is passed through the convolutional generator network 104 to project the data into the latent space 114. The K nearest neighbors of the entire text corpus are computed in this latent space, and are then converted back to the text space. A histogram over the words in the sentences offers a text-based description.

FIG. 2 is a histogram 200 of an example output of the classifier network 108 of the signal classification system 100 of FIG. 1 for a GFSK-modulated signal input. The histogram 200 includes a “GFSK” bin 202, a “modulation” bin 204, a “keying” bin 206, a “Gaussian” bin 208, a “demodulator” bin 210, a “frequency” bin 212, a “shift” bin 214, a “signal” bin 216, a “IEEE” bin 218, a “dll-based” bin 220, a “receiver” bin 222, a “frequency-shift” bin 224, a “FSK” bin 226, a “cancellation” bin 228, and a “using” bin 230.

The top result illustrated in the histogram 200 is the “GFSK” bin 202, which corresponds to the correct modulation type of the input signal (GFSK). The second to the top result is the “modulation” bin 204, which confirms that the input signal is a modulated signal. Most of the remainder of the top results correspond to other words in the acronym for GFSK (“Gaussian,” “frequency,” “shift,” and “keying”) including the “keying” bin 206 corresponding to the word “keying,” the “Gaussian” bin 208 corresponding to the word “Gaussian,” the “frequency” bin 212 corresponding to the word “frequency,” and the “shift” bin 214 corresponding to the word “shift.” This may be because these words are often used in sentences that describe the modulation GFSK; however, they may not technically offer any additional information.

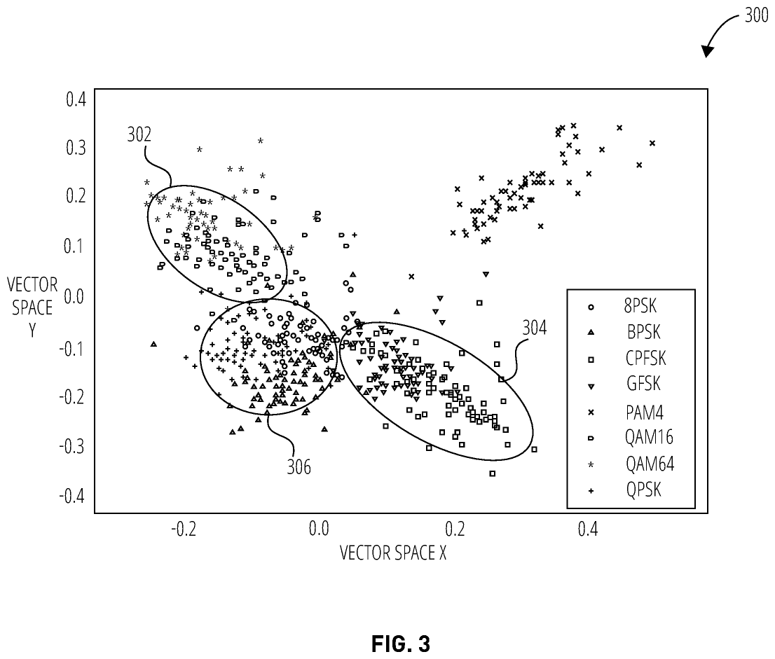

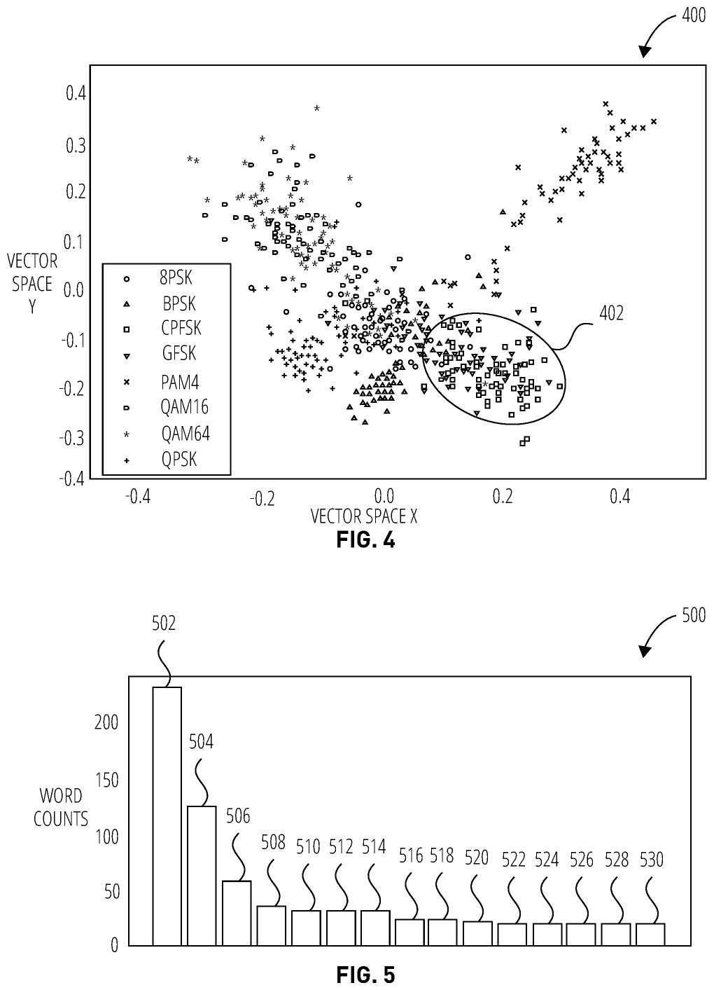

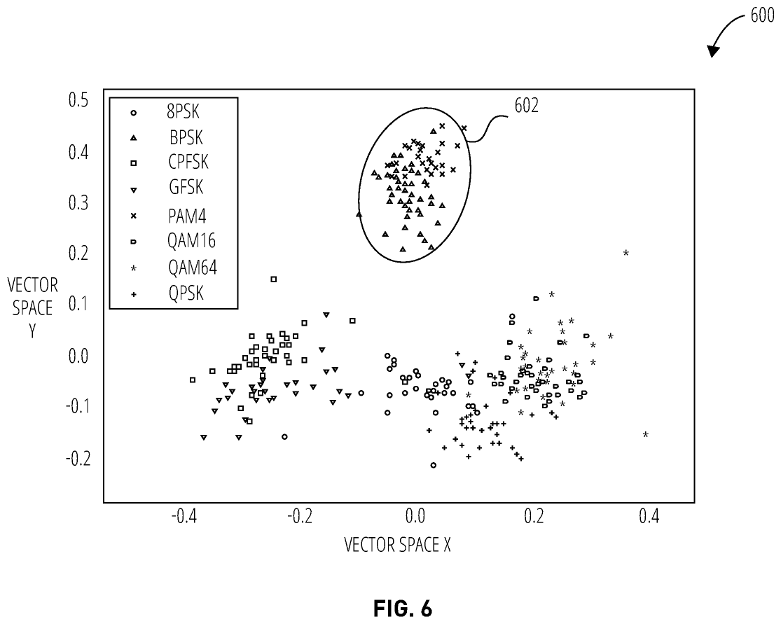

FIG. 3 is a plot illustrating an example of a latent space 300. The latent space 300 may be learned by the Doc2Vec model. The latent space 300 includes indicators of different types of modulation. Specifically, 8PSK modulation is marked using circles, BPSK modulation is marked using triangles pointing upwards, CPFSK modulation is marked using squares, GFSK modulation is marked using triangles pointing downwards, PAM4 modulation is marked using the letter “x,” QAM16 modulation is marked using bullet shapes, QAM64 is marked using the “*” symbol, and QPSK modulation is marked using the “+” symbol. This same marking convention for the various modulation schemes is followed in FIG. 4 and FIG. 6.

The latent space 300 shows reasonable cluster separation between different modulations. Modulations that are semantically similar to each other are grouped near each other. By way of non-limiting example, QAM16 and QAM64 modulations are substantially clustered together within QAM clusters 302, BPSK, QPSK, and 8PSK modulations are clustered together within PSK clusters 306, and CPFSK and GFSK modulations are clustered together within FSK clusters 304. The PAM4 marks are grouped substantially together away from the QAM clusters 302, the FSK clusters 304, and the PSK clusters 306.

Principle Component Analysis (PCA) may be used to project the 100-dimensional space learned by the Doc2Vec model to a 2D representation as seen in FIG. 3. This graphic shows a strong cluster for each of the modulation types, implying that a sentence containing the specific modulation word may be reasonably separated from sentences containing other modulation words. Further, modulations that are similar semantically appear near each other: QAM16/QAM64 (the QAM clusters 302), CPFSK/GFSK (the FSK clusters 304), and BPSK/QPSK/8PSK (the PSK clusters 306), as discussed above. The result from FIG. 3 implies that GAN is capable of successfully imitating this projection.

While the latent space 300 of FIG. 3 corresponds to a relatively strong result, the GAN was trained on all 8 modulations. This allowed the GAN to learn how to separate all modulations and implicitly learn a portion of the modulation recognition process.

FIG. 4 is a plot illustrating an example of a latent space 400 that is not trained for GFSK modulation. To inspect an approach to zero-shot learning, if GFSK is withheld during training, the GAN may learn a projection on N-1 classes, which may not be optimal for all possible classes. Inspecting the projection of IQ data into the latent space 400 reveals difficulty in separating classes with high similarities. The hold-out modulation GFSK is placed directly on top of a GFSK/CPFSK cluster 402 since the waveforms are similar. Further, the clusters for QAM16 and QAM64 are also co-located due to their similarities, despite both classes being present during training.

FIG. 5 is a histogram 500 of an example output of the classifier network 108 of the signal classification system 100 of FIG. 1 without GFSK training. The histogram 500 includes a “CPFSK” bin 502, a “modulation” bin 504, a “keying” bin 506, a “system” bin 508, a minimum shift keying bin (“MSK” bin 510), a “shift” bin 512, a “receiver” bin 514, a “BER” bin 516, a “frequency” bin 518, a “binary” bin 520, a “modula” bin 522, an “optical” bin 524, a “GPSK” bin 526, a “GFSK” bin 528, and a “Gaussian” bin 530.

FIG. 5 shows the histogram 500 when running inference on GFSK using the generator that was trained when GFSK was excluded. In this case, the top result does not correspond to the correct modulation (GFSK). The signal classification system 100 (FIG. 1), however, was able to yield a similar modulation (“CPFSK” bin 502) for the top result. Some of the other top results including “modulation” bin 504, “keying” bin 506, “shift” bin 512, and “frequency” bin 518 correspond to terms (modulation, keying, shift, and frequency, respectively) that correctly correspond to features of the correct modulation (GFSK). The last two results of the histogram 500, “GFSK” bin 528, “Gaussian” bin 530, correspond to terms that add the remaining information (“GFSK” and “Gaussian,” respectively). This result may be responsive to the similarities between the waveforms for CPFSK and GFSK, which align with the similarities between the words.

FIG. 6 is a plot illustrating an example of a latent space 600 that is not trained for BPSK modulation. FIG. 6 shows the latent space 600 learned by the generator when BPSK was excluded. This result shows the BPSK waveform is actually more similar to a waveform using PAM4 modulation than it is to the other PSK-based waveforms (QPSK and 8PSK), as the projected points for BPSK (upward pointing triangles) are near the projected PAM4 points (x symbols), forming a BPSK/PAM4 cluster 602. In this case, calculating the word histogram (not shown) for the BPSK signal may only yield descriptions that are close to PAM4, rather than the other PSK modulations. This is still a useful result, as PAM4 is similar to BPSK in that PAM4 is a low-order modulation. As discussed with reference to FIG. 4 and FIG. 5 (the GFSK/CPFSK example), the generator was able to successfully map the unknown input signal into a similar signal. Nevertheless, this example highlights the importance of a corpus where the semantic similarities match the similarities exhibited in the waveforms.

Deep learning architectures have been successfully applied to numerous domains including audio, image processing, and natural language processing. Disclosed herein are various embodiments relating to an application of generative neural networks to RF signal processing where deep neural networks are used to project IQ data into a latent space learned by a document embedding model.

The success of describing the GFSK waveform using the Doc2Vec model according to various embodiments disclosed herein shows that signal classification according to the various embodiments disclosed herein is viable. Rather than yielding only a single one-hot encoded vector to indicate the modulation of the input signal, words may be provided to describe the signal.

When exploring the application of various embodiments disclosed herein to zero-shot learning and estimating unknown signals, the results depend, at least in part, on the quality of the corpus. When GFSK was withheld (FIG. 4 and FIG. 5), the physical similarity between CPFSK and GFSK modulated signals align with the semantic similarity for CPFSK and GFSK. This allowed the word histogram (FIG. 5) to include words that correctly described GFSK. For the BPSK example (FIG. 6), the waveform was most similar with PAM4; however, the description of PAM4 was not accurate for BPSK other than the fact that both PAM4 and BPSK are low-order constellations.

A self-supervised feature extraction technique may be a better way to map IQ data into a feature space to provide extensibility to signals that were not labeled during training. Using this strategy, the generator would instead learn a translation from the input feature space to the target document embedding space, which may enhance how well the architecture generalizes to new data for zero-shot learning. Also, the RF datasets may be expanded to include sets of signals to allow the network to reason over ensembles of emitters; however, a corpus of text-based descriptions of the ensembles may be available to support training this type of model.

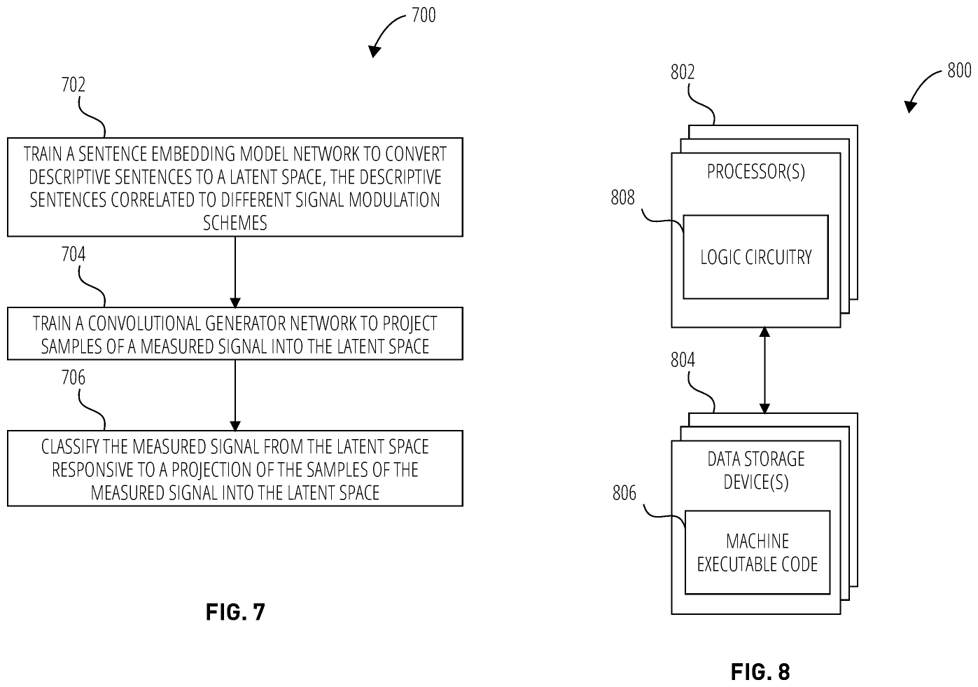

FIG. 7 is a flowchart illustrating a method 700 of operating a signal classification system, according to some embodiments. At operation 702 the method 700 includes training a sentence embedding model network to convert descriptive sentences to a latent space. The descriptive sentences are correlated to different signal modulation schemes. In some embodiments training the sentence embedding model network includes parsing a body of documents into descriptive sentences, segmenting the descriptive sentences into lists of word tokens, and training neural network weight matrices used for predicting a next word in a sentence based, at least in part, on a fixed-length context sample from a random document of the body of documents.

At operation 704 the method 700 includes training a convolutional generator network to project samples of a measured signal into the latent space. In some embodiments training the convolutional generator network includes training the convolutional generator as a generator of a generative adversarial network.

At operation 706 the method 700 includes classifying the measured signal from the latent space responsive to a projection of the samples of the measured signal into the latent space. In some embodiments classifying the measured signal comprises identifying a predetermined number of closest neighboring points in the latent space, and converting the predetermined number of closest neighboring points to a text space to provide a plurality of words that are descriptive of the measured signal. In some embodiments classifying the measured signal includes indicating one or more signal modulation schemes corresponding to the measured signal.

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 8 illustrates non-limiting examples of implementations of functional elements disclosed herein. In some embodiments, some or all portions of the functional elements disclosed herein may be performed by hardware specially configured for carrying out the functional elements.

FIG. 8 is a block diagram of circuitry 800 that, in some embodiments, may be used to implement various functions, operations, acts, processes, and/or methods disclosed herein. The circuitry 800 includes one or more processors 802 (sometimes referred to herein as “processors 802”) operably coupled to one or more data storage devices (sometimes referred to herein as “storage 804”). The storage 804 includes machine executable code 806 stored thereon and the processors 802 include logic circuitry 808. The machine executable code 806 includes information describing functional elements that may be implemented by (e.g., performed by) the logic circuitry 808. The logic circuitry 808 is adapted to implement (e.g., perform) the functional elements described by the machine executable code 806. The circuitry 800, when executing the functional elements described by the machine executable code 806, should be considered as special purpose hardware configured for carrying out functional elements disclosed herein. In some embodiments the processors 802 may be configured to perform the functional elements described by the machine executable code 806 sequentially, concurrently (e.g., on one or more different hardware platforms), or in one or more parallel process streams.

When implemented by logic circuitry 808 of the processors 802, the machine executable code 806 is configured to adapt the processors 802 to perform operations of embodiments disclosed herein. For example, the machine executable code 806 may be configured to adapt the processors 802 to perform at least a portion or a totality of the method 700 of FIG. 7. As another example, the machine executable code 806 may be configured to adapt the processors 802 to perform at least a portion or a totality of the operations discussed for the sentence embedding model 102, the convolutional generator network 104, the discriminator network 106, and/or the classifier network 108 of FIG. 1. As a further example, the machine executable code may be configured to adapt the processors 802 to train a sentence embedding model network to convert a body of sentences correlated to different signal modulation schemes into a latent space; train a convolutional generator network to project measured signals into the latent space; project samples of a measured signal to the latent space; and classify, with a classifier network, the signal according to one or more of the different signal modulation schemes based, at least in part, on a projection of the samples to the latent space; generate, with the convolutional generator network, data that mimics the samples of the measured signal; and distinguish, with a discriminator network, between the data and the samples.

The processors 802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 806 (e.g., software code, firmware code, hardware descriptions) related to embodiments of the present disclosure. It is noted that a general-purpose processor (may also be referred to herein as a host processor or simply a host) may be a microprocessor, but in the alternative, the processors 802 may include any conventional processor, controller, microcontroller, or state machine. The processors 802 may also be implemented as a combination of computing devices, such as a combination of a DSP and a microprocessor, a plurality of microprocessors, one or more microprocessors in conjunction with a DSP core, or any other such configuration.

In some embodiments the storage 804 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 802 and the storage 804 may be implemented into a single device (e.g., a semiconductor device product, a system on chip (SOC), etc.). In some embodiments the processors 802 and the storage 804 may be implemented into separate devices.

In some embodiments the machine executable code 806 may include computer-readable instructions (e.g., software code, firmware code). By way of non-limiting example, the computer-readable instructions may be stored by the storage 804, accessed directly by the processors 802, and executed by the processors 802 using at least the logic circuitry 808. Also by way of non-limiting example, the computer-readable instructions may be stored on the storage 804, transferred to a memory device (not shown) for execution, and executed by the processors 802 using at least the logic circuitry 808. Accordingly, in some embodiments the logic circuitry 808 includes electrically configurable logic circuitry 808.

In some embodiments the machine executable code 806 may describe hardware (e.g., circuitry) to be implemented in the logic circuitry 808 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 808 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine executable code 806 may include an HDL, an RTL, a GL description, a mask level description, other hardware description, or any combination thereof.

In embodiments where the machine executable code 806 includes a hardware description (at any level of abstraction), a system (not shown, but including the storage 804) may be configured to implement the hardware description described by the machine executable code 806. By way of non-limiting example, the processors 802 may include a programmable logic device (e.g., an FPGA or a PLC) and the logic circuitry 808 may be electrically controlled to implement circuitry corresponding to the hardware description into the logic circuitry 808. Also by way of non-limiting example, the logic circuitry 808 may include hard-wired logic manufactured by a manufacturing system (not shown, but including the storage 804) according to the hardware description of the machine executable code 806.

Regardless of whether the machine executable code 806 includes computer-readable instructions or a hardware description, the logic circuitry 808 is adapted to perform the functional elements described by the machine executable code 806 when implementing the functional elements of the machine executable code 806. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A signal classification system, comprising:
a sentence embedding model network trained to convert a body of sentences correlated to different signal modulation schemes into a latent space;
a convolutional generator network configured to project samples of a measured signal into the latent space; and
a classifier network configured to classify the measured signal from the latent space responsive to a projection of the samples of the measured signal into the latent space.

2. The signal classification system of claim 1, further comprising a discriminator network configured to attempt to distinguish outputs from the convolutional generator network from outputs from the sentence embedding model network.

3. The signal classification system of claim 1, wherein the classifier network is configured to classify the measured signal by indicating one of the different signal modulation schemes.

4. The signal classification system of claim 3, wherein the classifier network is further configured to classify the measured signal by indicating one or more words taken from the body of sentences that are proximate to the projection of the samples of the measured signal in the latent space.

5. The signal classification system of claim 1, wherein the classifier network is configured to classify the measured signal by providing a caption including a plurality of words taken from the body of sentences.

6. The signal classification system of claim 1, wherein the sentence embedding model network is configured to use a paragraph vector algorithm to generate unique vectors for each sentence of the body of sentences and for each word of the body of sentences.

7. The signal classification system of claim 6, wherein the sentence embedding model network is configured to use the unique vectors as features to predict a next word in a context.

8. The signal classification system of claim 1, wherein the latent space includes a one hundred dimensional embedding space.

9. A method of operating a signal classification system, the method comprising:
training a sentence embedding model network to convert descriptive sentences to a latent space, the descriptive sentences correlated to different signal modulation schemes; and
training a convolutional generator network to project samples of a measured signal into the latent space.

10. The method of claim 9, wherein training the sentence embedding model network comprises:
parsing a body of documents into the descriptive sentences;
segmenting the descriptive sentences into lists of word tokens; and
training neural network weight matrices used for predicting a next word in a sentence based, at least in part, on a fixed-length context sample from a random document of the body of documents.

11. The method of claim 9, wherein training the convolutional generator network comprises training the convolutional generator network das a generator of a generative adversarial network.

12. The method of claim 9, further comprising classifying the measured signal from the latent space responsive to a projection of the samples of the measured signal into the latent space.

13. The method of claim 12, wherein classifying the measured signal comprises identifying a predetermined number of closest neighboring points in the latent space, and converting the predetermined number of closest neighboring points to a text space to provide a plurality of words that are descriptive of the measured signal.

14. The method of claim 12, wherein classifying the measured signal comprises indicating one or more signal modulation schemes corresponding to the measured signal.

15. The method of claim 9, further comprising generating, with the convolutional generator network, data to mimic the samples of the measured signal.

16. The method of claim 15, further comprising distinguishing between the data provided by the convolutional generator network from outputs originating at the sentence embedding model network.

17. A computer-readable medium having computer-readable instructions stored thereon, the computer-readable instructions configured to instruct one or more processors to:
train a sentence embedding model network to convert a body of sentences correlated to different signal modulation schemes into a latent space;
train a convolutional generator network to project measured signals into the latent space;
project samples of a measured signal to the latent space; and
classify, with a classifier network, the measured signal according to one or more of the different signal modulation schemes based, at least in part, on a projection of the samples to the latent space.

18. The computer-readable medium of claim 17, wherein the computer-readable instructions are further configured to instruct the one or more processors to:
generate, with the convolutional generator network, data that mimics the samples of the measured signal; and
distinguish, with a discriminator network, between the data and the samples.

19. The computer-readable medium of claim 17, wherein the classifier network is configured to use information obtained from training the convolutional generator network to classify the measured signal based, at least in part, on the latent space.

20. The computer-readable medium of claim 17, wherein the computer-readable instructions are configured to instruct the one or more processors to train the sentence embedding model network to convert the body of sentences into the latent space based, at least in part, on a prediction of a next word in a sentence given a context.
